(19) United States
(12) Patent Application Publication
(10) Pub. No.: US 2009/0065604 A1
(43) Pub. Date: Mar. 12, 2009

(54) Home cooling system

(76) Inventor: Wally Lucrecia De La Puente, Beverly Hills, CA (US)

Correspondence Address: WAKKY DE LA PUENTE, 253 S. CLARK DRIVE, Beverly Hills, CA, 90211, US

(21) Appl. No.: 11/899,307

(22) Filed: Sep. 6, 2007

(51) Int. Cl. B05B 17/00

(52) U.S. Cl. 239/13

(57) ABSTRACT

I claim that this embodiment is the placement of sprinkler systems on roof tops to cool structures during hot weather.

This embodiment represents a methodology for cooling homes during hot weather. It involves the placement of water sprinklers on roof tops. By the occasional drenching of roof tops with water, structures can be quickly cooled. A secondary benefit would be a well placed water source to serve as additional fire protection.

Currently it seems that air conditioning is the only method being used to cool homes. This water cooling method can serve as an adjunct to air conditioning, thereby lowering some of the need for air conditioning. Therefore, this method, in conujunction with air conditioning will result in a savings of electricity incurred when air conditioning alone employed, which will be especially helpful during peak summer months when high electricity usage can over tax the electrical grid systems. The sprinkers would be expected to be used intermittently.

The Sprinkler pattern will depend on the shape and size of the roof. For example, sprinklers will be distributed in rows on flat roofs, whereas on slanted roofs, sprinklers will be positioned on the top with braces, allowing the water to flow down evenly. The sprinklers can be used intermittently. The sprinklers system is expected to be used f or a period of 15 minutes every two or three hours as needed. A timer with a thermostatic device can be employed if desired.

### DESCRIPTION OF THE DRAWINGS

Architectural FIG. 1 attempts to illustrate a rooftop dotted with sprinkers. The dots signify sprinkler heads. The arrows on FIG. 1 point to downward directions of a slanted roof.

FIG. 2 attempts to illustrate a flat type rooftop dotted with sprinklers, spaced appropriately, perhaps every 9 feet. The dots signify sprinkler heads.

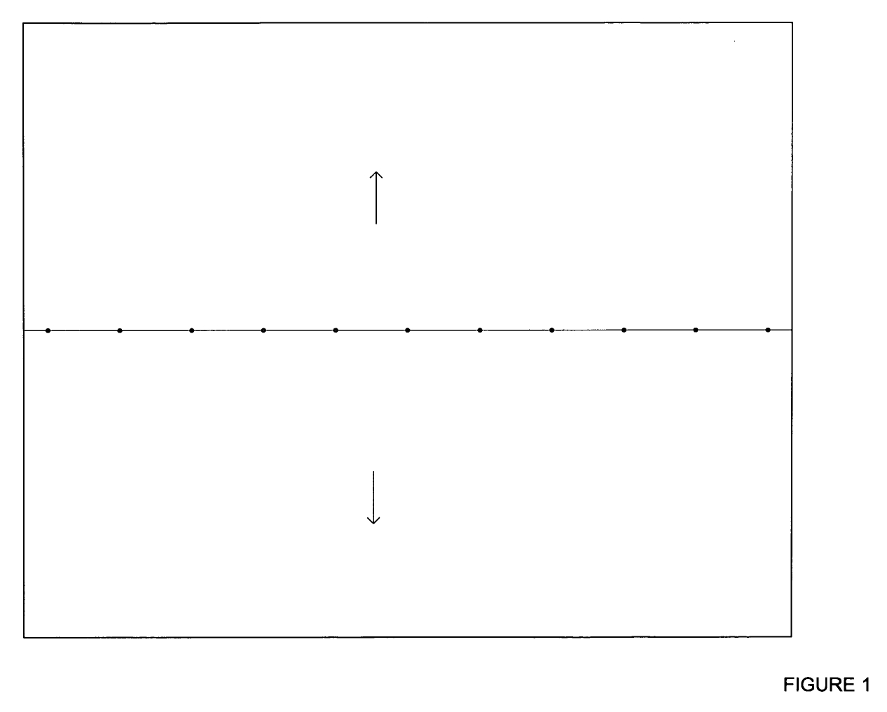

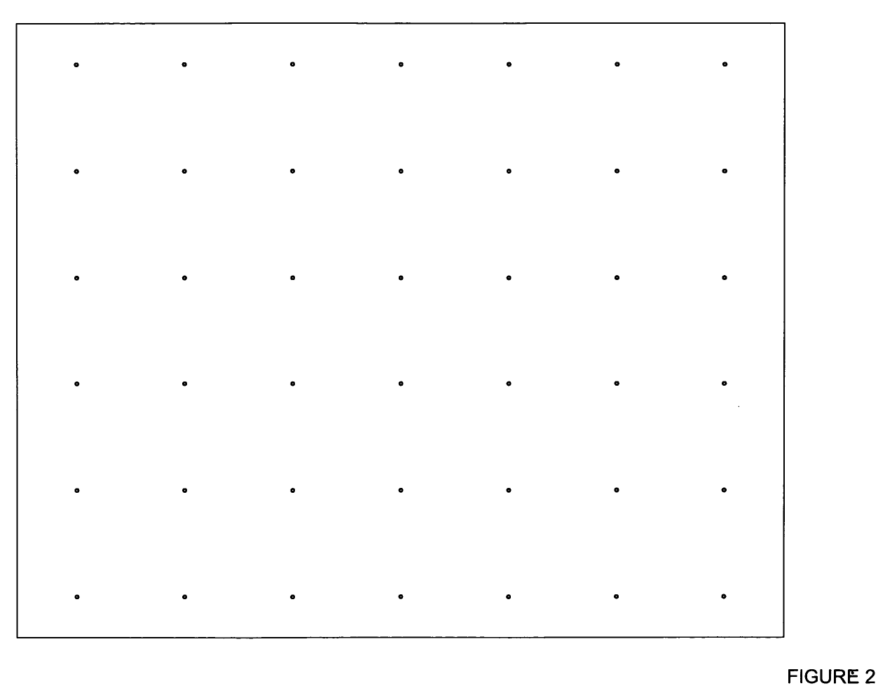

1. I claim that this embodiment is the placement of sprinkler systems on roof tops to cool structures during hot weather.
